(19) United States
(12) Patent Application Publication
(10) Pub. No.: US 2018/0048924 A1
(43) Pub. Date: Feb. 15, 2018

(54) TRANSMISSION APPARATUS AND TRANSMISSION METHOD, RECEPTION APPARATUS AND RECEPTION METHOD, TRANSMISSION SYSTEM, AND PROGRAM

(71) Applicant: Sony Corporation, Tokyo (JP)

(72) Inventor: Takashi Yokokawa, Kanagawa (JP)

(21) Appl. No.: 15/554,375

(22) PCT Filed: Mar. 10, 2016
(86) PCT No.: PCT/JP2016/057543

§ 371 Date: Aug. 29, 2017

(30) Foreign Application Priority Data
Mar. 24, 2015 (JP) 2015-060806

(51) Int. Cl. H04N 21/24; H04N 21/436; H04N 21/4363; H04L 1/00

(52) U.S. Cl. CPC H04N 21/2404; H04L 1/0009; H04N 21/436; H04N 21/43632

(57) ABSTRACT

The present technology relates to a transmission apparatus and a transmission method, a reception apparatus and a reception method, a transmission system, and a program by which the communication efficiency can be enhanced and power saving can be realized in transmitting and receiving additional data instead of audio data in addition to visible image data in a DisplayPort (trademark) standard.

In the DisplayPort (trademark) standard, the visible image data is provided with a format by which audio data can be transmitted in addition to the visible image data. In transmitting other additional data by using this format for transmitting the audio data, a part of an error correction code included in the format is omitted if high reliability is not required unlike the audio data. The present technology is applicable to a display port.

### TECHNICAL FIELD

The present technology relates to a transmission apparatus and a transmission method, a reception apparatus and a reception method, a transmission system, and a program and particularly to a transmission apparatus and a transmission method, a reception apparatus and a reception method, a transmission system, and a program by which efficient use of a communication bandwidth and a reduction in power consumption can be realized.

### BACKGROUND ART

A standard of an interface that transmits image data to a display, which is called DisplayPort (trademark), is commonly used (e.g., see Non-Patent Literature 1).

### CITATION LIST

### Non-Patent Literature

Non-Patent Literature 1: DisplayPort (trademark) Version1.2a VESA (Video Electronics Standards Association)

### DISCLOSURE OF INVENTION

### Technical Problem

By the way, in the DisplayPort (trademark) standard, transmitting audio data in addition to visible image data formed of effective pixel data is defined. It is possible to transmit and receive them together.

In transmitting the audio data in addition to the visible image data formed of the effective pixel data in this DisplayPort (trademark) standard, an error correction function formed of 4-byte parity data is set with respect to 16-byte audio data. With this, the audio data is protected.

On the other hand, in this DisplayPort (trademark) standard, it is conceivable that other additional data instead of the audio data in addition to the visible image data formed of the effective pixel data can be transmitted by using a mechanism for transmitting the audio data.

However, in the DisplayPort (trademark) standard, there is a fear that this error correction function may be overprotective in transmitting and receiving, in addition to the visible image data, the additional data that does not require high reliability unlike the audio data. As a result, it can result in lowered communication efficiency and increased power consumption associated with communication.

The present technology has been made in view of the above-mentioned circumstances particularly to enable an enhancement of communication efficiency and a reduction in power consumption due to efficient use of a communication bandwidth in transmitting additional data in addition to visible image data in a communication standard used for an interface of the existing display port (DisplayPort (trademark)) to be realized.

### Solution to Problem

A transmission apparatus according to an aspect of the present technology is a transmission apparatus that transmits visible image data formed of effective pixel data of an image pickup apparatus by using a format for transmitting to a display, the transmission apparatus including a transmitter that transmits audio data in addition to the visible image data, in which in the format, an error correction code having a predetermined amount is set with respect to the audio data having a predetermined amount, and the transmitter transmits, transmitting additional data different from the audio data instead of the audio data in addition to the visible image data, the additional data and the visible image data by using the format from which a part of the error correction code is omitted.

The transmitter can inquire a transmission destination about whether or not the additional data can be transmitted with the part of the error correction code included in the format being omitted, and transmit the additional data in addition to the visible image data by using the format from which the part of the error correction code is omitted if the additional data can be transmitted with the part of the error correction code included in the format being omitted.

The transmitter can use the format for transmitting to the display and packetize and transmit phase detection image data in the image pickup apparatus as the additional data.

The format for transmitting to the display can be a format defined by DisplayPort (trademark), and the transmitter can use an SDP (Secondary-Data Packet) defined by DisplayPort (trademark) as the format for transmitting to the display and packetize and transmit the phase detection image data as the additional data in the image pickup apparatus.

The transmitter can use a phase detection image information packet and a phase detection image data packet of the SDP (Secondary-Data Packet) defined by DisplayPort (trademark) and packetize and transmit the phase detection image data as the additional data in the image pickup apparatus.

The transmitter can arrange the phase detection image information packet in a vertical blanking region, arrange the phase detection image data packet in a horizontal blanking region, and packetize and transmit the phase detection image data.

The phase detection image information packet can include information on the number of lines per frame and the number of pixels per line of the phase detection image constituted by the phase detection image data, the number of bits per pixel, and the number of pixels per piece of the phase detection image data.

The transmitter can package and transmit the phase detection image data packet in units of predetermined bytes.

A transmission method for a transmission apparatus according to an aspect of the present technology is a transmission method for a transmission apparatus that transmits visible image data formed of effective pixel data of an image pickup apparatus by using a format for transmitting to a display, the transmission method including a transmission step of transmitting audio data in addition to the visible image data, in the format, an error correction code having a predetermined amount is set with respect to the audio data having a predetermined amount, and processing of the transmission step includes transmitting, transmitting additional data different from the audio data instead of the audio data in addition to the visible image data, the additional data and the visible image data by using the format from which a part of the error correction code is omitted.

A program according to an aspect of the present technology is a program that causes a computer that controls a transmission apparatus that transmits visible image data formed of effective pixel data of an image pickup apparatus by using a format for transmitting to a display to execute processing including a transmission step of transmitting phase detection image data in the image pickup apparatus in addition to the visible image data, in which in the format, an error correction code having a predetermined amount is set with respect to the audio data having a predetermined amount, and processing of the transmission step includes transmitting, transmitting additional data different from the audio data instead of the audio data in addition to the visible image data, the additional data and the visible image data by using the format from which a part of the error correction code is omitted.

A reception apparatus according to an aspect of the present technology is a reception apparatus that receives visible image data formed of effective pixel data of an image pickup apparatus by using a format for transmitting to a display, the reception apparatus including a receiver that receives audio data in the image pickup apparatus in addition to the visible image data, in which in the format, an error correction code having a predetermined amount is set with respect to the audio data having a predetermined amount, and the receiver receives, in receiving additional data different from the audio data instead of the audio data in addition to the visible image data, the additional data and the visible image data by using the format from which a part of the error correction code is omitted.

A reception method according to an aspect of the present technology is a reception method for a reception apparatus that receives visible image data formed of effective pixel data of an image pickup apparatus by using a format for transmitting to a display, the reception method including a step of receiving audio data in the image pickup apparatus in addition to the visible image data, in which in the format, an error correction code having a predetermined amount is set with respect to the audio data having a predetermined amount, and processing of the reception step includes receiving, in receiving additional data different from the audio data instead of the audio data in addition to the visible image data, the additional data and the visible image data by using the format from which a part of the error correction code is omitted.

A program according to an aspect of the present technology is a program that causes a computer that controls a reception apparatus that receives visible image data formed of effective pixel data of an image pickup apparatus by using a format for transmitting to a display to execute processing including a reception step of receiving audio data in the image pickup apparatus in addition to the visible image data, in the format, an error correction code having a predetermined amount is set with respect to the audio data having a predetermined amount, and processing of the reception step includes receiving, in receiving additional data different from the audio data instead of the audio data in addition to the visible image data, the additional data and the visible image data by using the format from which a part of the error correction code is omitted.

A transmission system according to an aspect of the present technology is a transmission system including: a transmission apparatus that transmits visible image data formed of effective pixel data of an image pickup apparatus by using a format for transmitting to a display; and a reception apparatus, in which the transmission apparatus includes a transmitter that transmits, to the reception apparatus, audio data in the image pickup apparatus in addition to the visible image data, in the format, an error correction code having a predetermined amount is set with respect to the audio data having a predetermined amount, the transmitter transmits, transmitting additional data different from the audio data instead of the audio data in addition to the visible image data, the additional data and the visible image data by using the format from which a part of the error correction code is omitted, the reception apparatus includes a receiver that receives, from the transmission apparatus, the audio data in the image pickup apparatus in addition to the visible image data, and the receiver receives, in receiving the additional data different from the audio data instead of the audio data in addition to the visible image data, the additional data and the visible image data by using the format from which the part of the error correction code is omitted.

The transmission apparatus and the reception apparatus according to the aspects of the present technology may be independent apparatuses or may be blocks that perform transmission processing.

Advantageous Effects of Invention

In accordance with the aspects of the present technology, it becomes possible to realize efficient use of a communication bandwidth and a reduction in power consumption in transmitting additional data in addition to visible image data in a communication standard used for an interface of the existing display port.

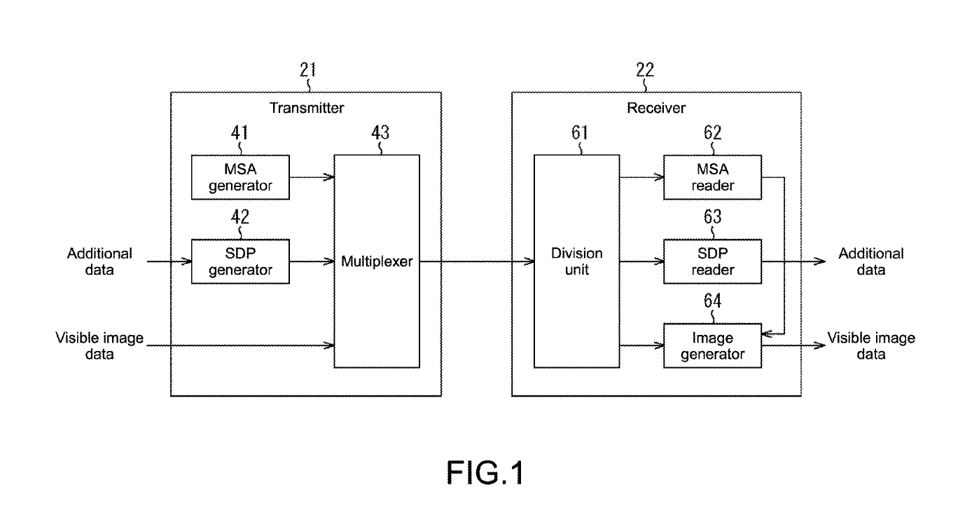

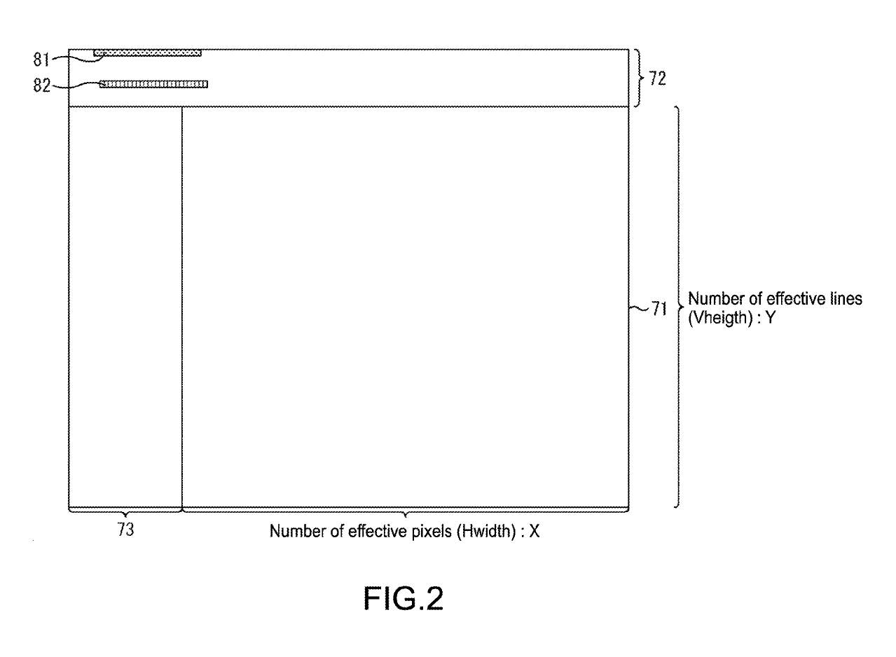

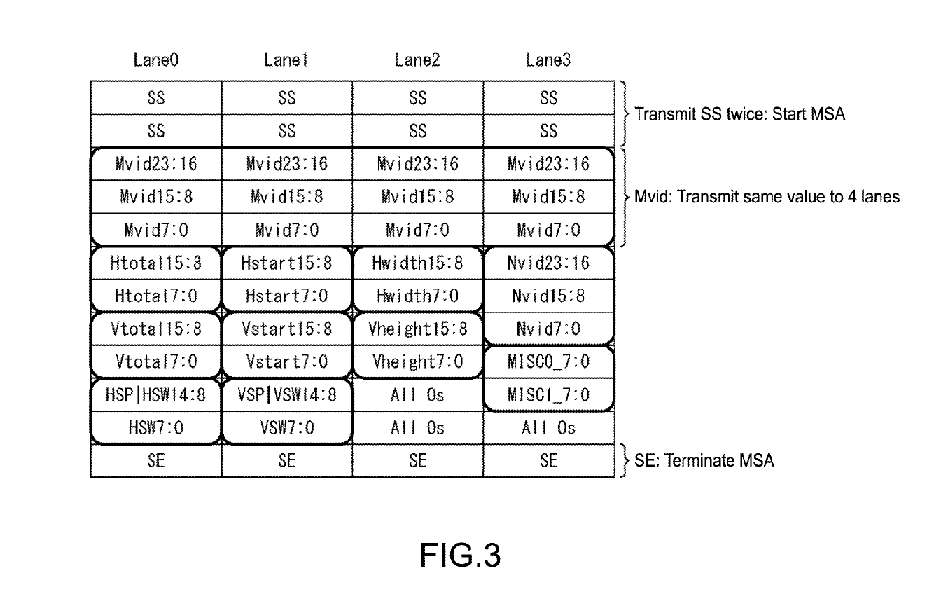

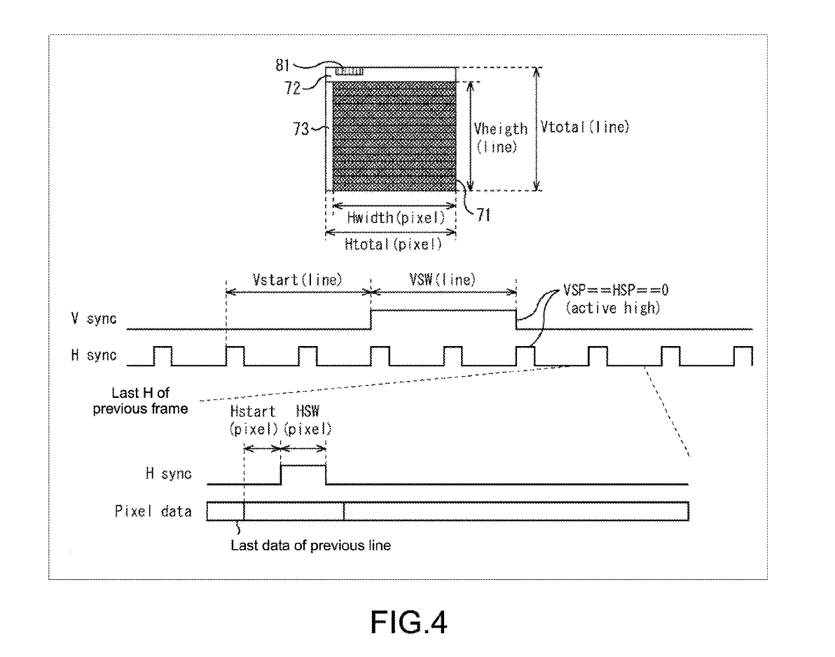

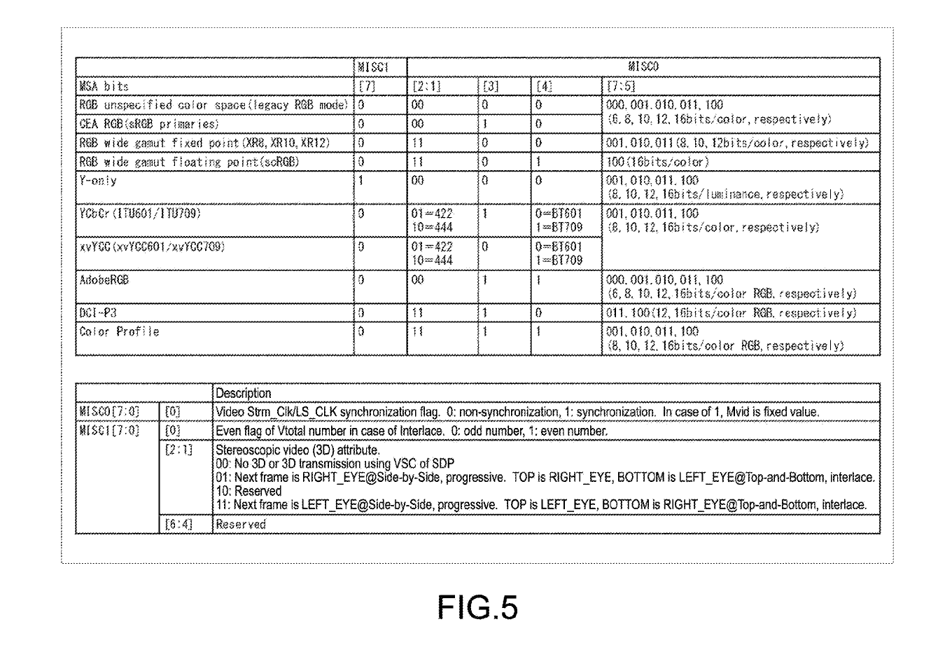

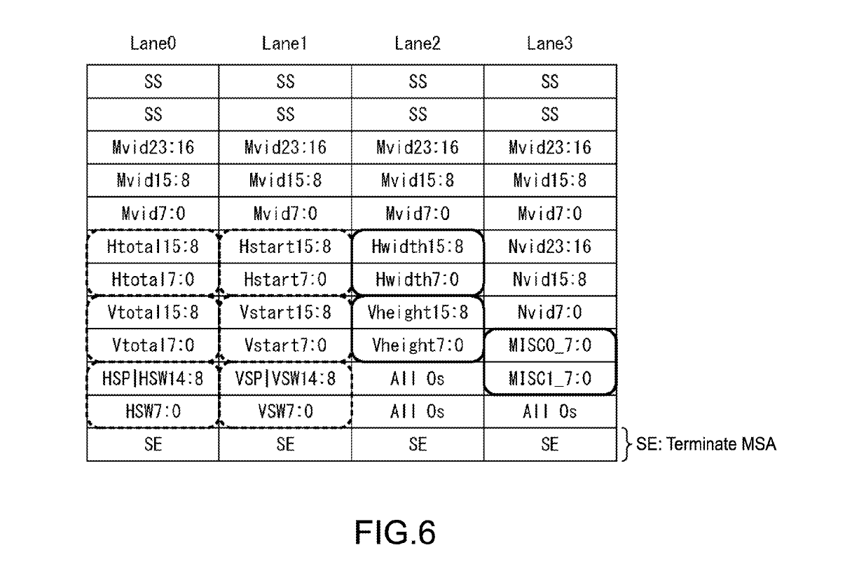

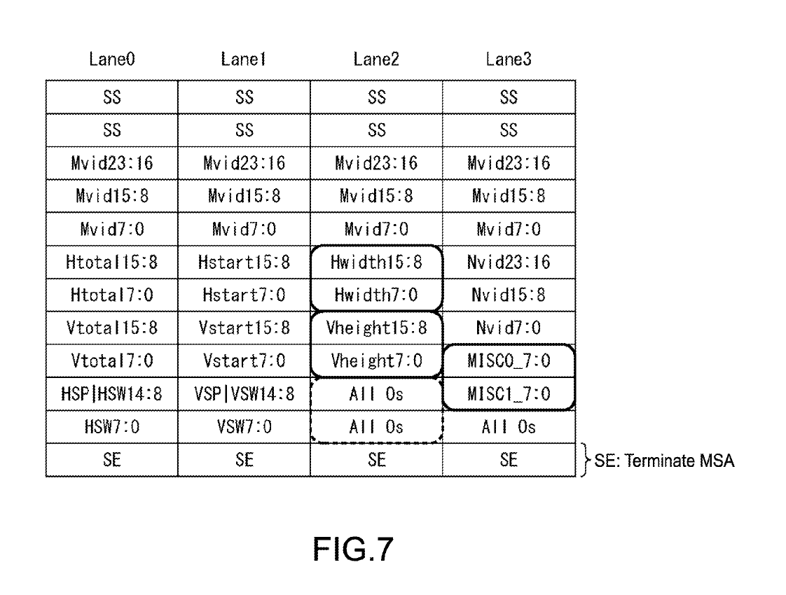

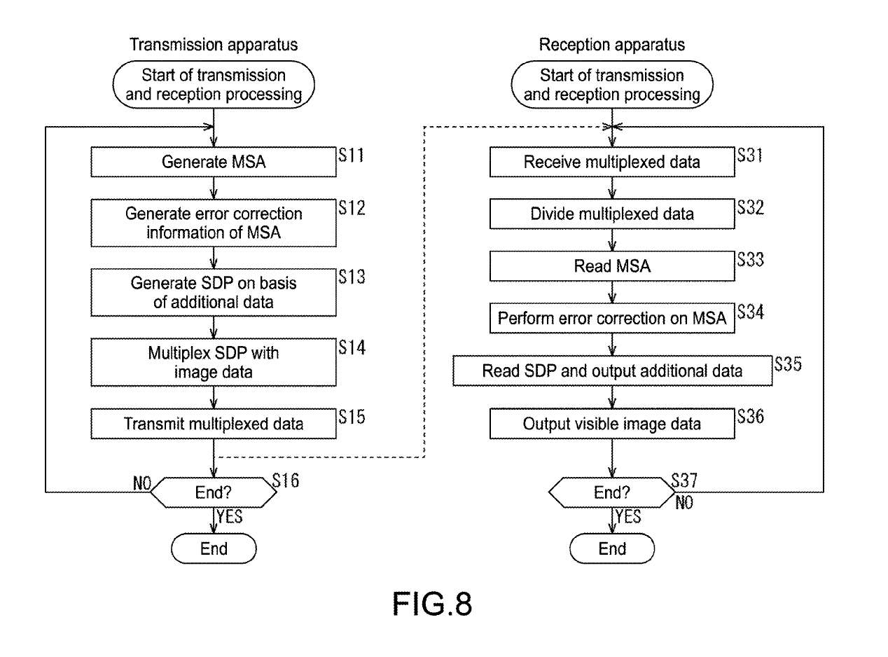

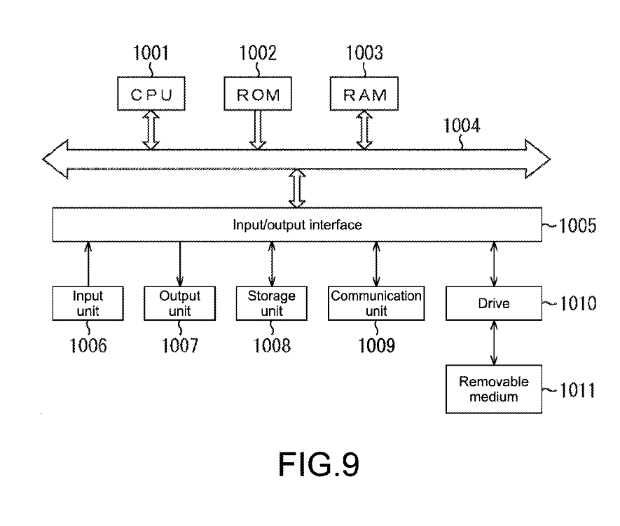

### BRIEF DESCRIPTION OF DRAWINGS

[FIG. 1] A diagram showing a configuration example of a first embodiment of a transmission system to which the present technology is applied.

[FIG. 2] A diagram describing a ZAF pixel.

[FIG. 3] A diagram describing MSA and SDP.

[FIG. 4] A diagram describing MSA and SDP.

[FIG. 5] A diagram describing a configuration of a phase detection image information packet of the SDP.

[FIG. 6] A diagram describing a transmission form formed of a normal format of a phase detection image information packet of the SDP.

[FIG. 7] A diagram describing a transmission form formed of a format from which parity of the phase detection image information packet of the SDP is omitted.

[FIG. 8] A diagram describing a transmission form of a configuration of the phase detection image data packet of the SDP.

[FIG. 9] A diagram describing a transmission form of the MSA.

[FIG. 10] A diagram describing a configuration of the MSA.

[FIG. 11] A diagram describing a configuration of the MSA.

[FIG. 12] A flowchart describing transmission and reception processing by the transmission system of FIG. 1.

[FIG. 13] A diagram describing a configuration example of a general-purpose personal computer.

### MODE(S) FOR CARRYING OUT THE INVENTION

<Configuration Example of Transmission System Using Secondary-Data Packet>

FIG. 1 shows a configuration example of an embodiment of a transmission system to which the present technology is applied. The transmission system of FIG. 1 is a system that transmits image data generated (captured) by an image pickup apparatus (not shown).

More specifically, the transmission system of FIG. 1 is constituted by a transmitter 21 and a receiver 22. In addition to visible image data supplied by the image pickup apparatus (not shown), the transmitter 21 transmits, to the receiver 22, phase detection image data (ZAF image data) according to a format of DisplayPort (trademark) that is a standard for transmitting to a display, which is called SDP (Secondary-Data Packet). The receiver 22 receives the phase detection image data together with visible image data transmitted from the transmitter 21. In the format of DisplayPort (trademark), which is called SDP (Secondary-Data Packet), transmitting the audio data in addition to the visible image data is defined. In the transmission system of FIG. 1, the phase detection image data is transmitted and received in addition to the visible image data instead of the audio data by using this format. Note that the phase detection image will be referred to as a ZAF image hereinafter. Further, in the present specification, it is assumed that an image is constituted by a plurality of pixels and image data is constituted by pixel data that is data on pixel values and the like of a plurality of pixels.

<Regarding ZAF Pixel>

In pixels set in an image pickup region, ZAF pixels are arranged at predetermined intervals in addition to effective pixels that generate visible image data. As such ZAF pixels, there are a left light shielding pixel with the left half of the pixel being shielded and a right light shielding pixel with the right half of the pixel being shielded. An image captured by each pixel is deviated to the left or right in a manner that depends on a focal distance. Therefore, regarding an image at a focal point, an image at the left light shielding pixel coincides with an image at the right light shielding pixel. Meanwhile, regarding an image deviated from the focal point, a phase difference depending on an amount of deviation of the focal distance is caused between the respective images. In view of this, it is possible to quickly adjust the focal point by determining the amount of deviation of the focal distance on the basis of this phase difference and adjusting the focal point.

ZAF pixels are arranged as shown in FIG. 2, for example. FIG. 2 shows a pixel arrangement example within an effective pixel region. In FIG. 2, each square indicates a pixel. White squares are normal RGB pixels and squares the left or right half region of each of which is provided with a light shielding section shown by oblique lines are ZAF pixels. As shown in the figure, the ZAF pixels are alternately arranged at three-line intervals and at five-line intervals in a vertical direction and arranged at eight-pixel intervals in a horizontal direction. Therefore, in the example of FIG. 2, the number of ZAF pixels is set to be, in the horizontal direction, ⅛ of the total number of pixels of the effective pixel region and to be, in the vertical direction, ¼ of the total number of pixels of the effective pixel region. Therefore, in the example of FIG. 2, the number of ZAF pixels is 1/32 of the total number of pixels of the effective pixel region.

Next, configurations of the transmitter 21 and the receiver 22 in the transmission system of FIG. 1 will be described.

The transmitter 21 includes an MSA generator 41, an SDP generator 42, a multiplexer 43, a controller 44, and an AUX (auxiliary communication unit) 45.

The MSA generator 41 generates MSA (Main Stream Attributes) that are image property information such as the number of lines per frame, the number of pixels per line, the number of bits per pixel, and the like of image data (visible image data) formed of effective pixel data, which is to be transmitted, and supplies them to the multiplexer 43. Note that the MSA will be described later in detail with reference to FIGS. 9 to 11.

The SDP generator 42 is controlled by the controller 44 to generate packets, which are called SDP (Secondary-Data Packets), according to a format for packetizing and transmitting ZAF pixel data in a horizontal blanking region and a vertical blanking region other than an effective pixel region and supplies them to the multiplexer 43. Note that the SDP will be described later in detail with reference to FIGS. 3 to 8.

The multiplexer 43 multiplexes the MSA supplied from the MSA generator 41, the SDP supplied from the SDP generator 42, and image data (visible image data) formed of input effective pixel data and outputs them as multiplexed data.

The controller 44 comprehensively controls operations of the transmitter 21. The controller 44 communicates with the receiver 22 that is a transmission destination via the AUX (auxiliary communication unit) 45, determines whether or not the receiver 22 is compatible with a form from which parity is omitted, which will be described later, as the form of the SDP, and instructs the SDP generator 42 to generate the SDP in a manner that depends on the determination result.

The receiver 22 includes a division unit 61, an MSA reader 62, an SDP reader 63, an image generator 64, an AUX (auxiliary communication unit) 65, a controller 66, and a register 67. The division unit 61 divides multiplexed data transmitted from the transmitter 21 into MSA, SDP, and visible image data and supplies the MSA to the MSA reader 62, the SDP to the SDP reader 63, and the visible image data to the image generator 64.

The MSA reader 62 reads, on the basis of the supplied MSA, the information on the number of lines per frame, the number of pixels per line, and the number of bits per pixel of the visible image data and supplies the read information to the image generator 64.

The SDP reader 63 is controlled by the controller 66 to read the SDP and extract and output the additional data such as the packetized ZAF image data.

The image generator 64 acquires visible image data and reconfigures and outputs the visible image on the basis of the information on the MSA.

The controller 66 comprehensively controls operations of the receiver 22. The controller 66 communicates with the transmitter 21 via the AUX (auxiliary communication unit) 65, reads information indicating whether or not the receiver 22 itself is compatible with a form in which the number of parity bytes is small, which will be described later, as the form of the SDP, and causes the transmitter 21 to transmit the result. Here, the information is stored in the register 67 in advance. Further, the controller 66 instructs the SDP reader 63 to perform corresponding processing on the basis of the information recorded in the register 67, which indicates whether or not it is compatible with the form in which the number of parity bytes is small, which will be described later.

<Regarding SDP (Secondary-Data Packet)>

Next, the SDP will be described.

The SDP uses the horizontal blanking region and the vertical blanking region with respect to each frame and packetizes and transmits data other than the visible image data (effective pixel data). Further, the SDPs are classified into two types of phase detection image information packets and phase detection image data packets.

The phase detection image information packet is a packet including information on the number of lines per frame and the number of pixels per line of the ZAF image data, the number of bits per pixel, and the number of pixels per ZAF pixel data.

Further, the phase detection image data packet constitute a plurality of pieces of ZAF pixel data itself.

The phase detection image information packet and the phase detection image data packet are, for example, packetized data arranged as shown in FIG. 3 within an image of one frame.

Note that, in FIG. 3, a region of ((number of effective pixels (Hwidth): X)×(number of effective lines (Vheight): Y)) shown in the lower right part is the effective pixel region 71. Further, lines L1 to L15 within the effective pixel region 71 are lines in which the ZAF pixels are present. Regarding the intervals of the respective lines, if they are similar to FIG. 2, for example, the interval between the lines L1 and L2 is five lines, the interval between the lines L2 and L3 is three lines, and thereafter, the three lines and the five lines are alternately repeated as the intervals.

Above the effective pixel region 71, there is provided a vertical blanking region (Vblank) 72, in which MSA 81 and phase detection image information packets 82 of SDP are arranged.

Further, on a left-hand side of the effective pixel region 71, there is provided a horizontal blanking region (Hblank) 73. Phase detection image data packets 83-1 to 83-15 are arranged at a level lower by one line than each line in which the ZAF pixels in the effective pixel region 71 are present. Thus, also regarding lines in which the phase detection image data packets 83-1 to 83-15 are arranged, they are arranged at alternate intervals of the three lines and the five lines with respect to the vertical direction. Note that, if the phase detection image data packets 83-1 to 83-15 do not have to be distinguished from one another, they will be simply referred to as phase detection image data packets 83 and other configurations will be also referred in a similar way.

Thus, in FIG. 3, only about ¼ of the phase detection image data packets 83 is used in the horizontal blanking region (Hblank) 73. In view of this, each phase detection image data packet 83 is divided into four parts and they are folded and arranged in lines in which no phase detection image data packet 83 is arranged. The arrangement as shown in FIG. 4, for example, can be thus obtained. With such an arrangement, it becomes possible to cause the horizontal blanking region (Hblank) 73 required by the phase detection image data packets 83 to be ¼ with respect to the horizontal direction.

<Regarding Configuration of Phase Detection Image Information Packet>

Next, a configuration of the phase detection image information packet 82 will be described with reference to FIG. 5. The packet header of the SDP defined by DisplayPort (trademark) is constituted by four bytes of HB0 to HB3 shown in the upper section of FIG. 5. In HB0 that is a top byte, information for identifying a handled phase detection image is recorded. Therefore, with the same phase detection image, the same value is used.

In HB1 that is a 2nd byte, information indicating a packet type (Secondary-Data Packet type) is recorded. In this HB1, for determining the display type in advance, a predetermined display type is set with respect to 00h to 07h while h08 to 0Fh are not set (DisplayPort RESERVED). In view of this, information indicating the phase detection image information packet is allocated to any of the not set 08h to 0Fh. For example, 08h may be allocated as the information indicating the phase detection image information packet.

HB2 and HB3 that are 3rd and 4th bytes are unused (Reserved (all 0)).

Regarding the data packets of the phase detection image information packet, as shown in the lower part of FIG. 5, information of low-order 8 bits of the number of lines per V of the phase detection image data is recorded in DB0 that is a top byte. Further, information of high-order 8 bits of the number of lines per V of the phase detection image data is recorded in DB1 that is a 2nd byte. The number of lines per V described here is the number of lines of the lines L1 to L15 in FIG. 3, for example.

In DB2 that is a 3rh byte, information of low-order 8 bits of the number of pixels per H of the phase detection image data is recorded. Further, in DB3 that is a 4th byte, information of high-order 8 bits of the number of pixels per V of the phase detection image data is recorded. The number of pixels per H described here is the number of phase detection pixels included in each of the lines L1 to L15 in FIG. 3, for example.

In DB4 that is a 5th byte, information of low-order 8 bits of the number of pixels per packet of the phase detection image data packet is recorded. Further, in DB5 that is a 6th byte, information of high-order 8 bits of the number of pixels per packet of the phase detection image data packet is recorded.

In DB6 that is a 7th byte, information on the number of bits per pixel of the phase detection image data packet is recorded. Further, DB7 to DB15 that are 8th to 16th bytes are set to be unused regions (Reserved (all 0)).

<Transmission Form in Normal Format>

Next, a format in transmission of the SDP will be described with reference to FIGS. 6 and 7. Note that, although a case of the four lanes will be described in this example, another number of lanes may be employed. Note that the format in the transmission includes a normal format and one in the form that omits the parity. First of all, the normal format will be described with reference to FIG. 6. In the normal format, the transmission form of data chronologically arranged in an up-to-down direction regarding Lane 0 to Lane 3 from the left to the right as shown in FIG. 6 is shown. Below control codes SS indicating the start of the SDP, the headers HB0 to HB3 are configured from the lane 0 to the lane 3 and one byte is arranged for each lane.

Below the headers HB0 to HB3 in the figure, parity PB0 to PB3 is configured and one byte is arranged for each of the lanes from the lane 0 to the lane 3.

Below the parity PB0 to PB3 in the figure, the data DB0 to DB15 are arranged with four bytes being downwardly arranged for each lane and a total of 16 bytes are arranged. Specifically, the data DB0 to DB3 are arranged with respect to the lane 0, the data DB4 to DB7 are arranged with respect to the lane 1, DB8 to DB11 are arranged with respect to the lane 2, and DB12 to DB15 are arranged with respect to the lane 3.

Below the data DB0 to DB15 of the respective lanes in the figure, parity PB4 to PB7 is configured and one byte is arranged for each of the lanes from the lane 0 to the lane 3.

In addition, regarding the lanes 0 to 2 below the parity PB4 to PB7 in the figure, each set of four bytes of the data DB16 to DB27 is arranged downwardly. That is, the data DB16 to DB19 are downwardly arranged with respect to the lane 0, DB20 to DB23 are downwardly arranged with respect to the lane 1, and DB24 to DB27 are downwardly arranged with respect to the lane 2. Note that data that should be transmitted is 28 bytes, and hence the lane 3 is set to be All 0s and blank.

In addition, below the data of each lane, the parity PB8 to PB11 is configured and one byte is arranged for each of the lanes from the lane 0 to the lane 3. In the bottom row, SE indicating the end of the SDP is arranged for each lane.

In this manner, the 4-byte parity is added to the 16-byte data and they are transferred.

<Transmission Form in Format That is Form That Omits Parity>

Next, the format in the form that omits the parity will be described with reference to FIG. 7. Note that configurations identical to those of the format described above with reference to FIG. 6 will be denoted by identical names and descriptions thereof will be appropriately omitted.

That is, in the format in the form that omits the parity of FIG. 7, a difference from the format shown in FIG. 6 is in that the parity PB0 to PB4 provided directly under the headers remains and other parity is deleted.

The normal format of FIG. 6 is a format set in transmitting audio data in addition to the visible image data, and hence it is necessary to ensure the sound quality in real-time communication. Therefore, the 4-byte parity is provided for each set of 16-byte audio data. However, data added in the present technology is not audio data but phase detection image data. Even if any frame with lowered quality is present in real-time communication, it does not impose significant influence as long as it is normal in a next frame. Therefore, even if parity that is the error correction function is omitted with respect to the phase detection image data, its influence is small. In view of this, if data transmitted and received as the additional data does not require high quality in real-time communication, the format from which the parity is omitted as shown in FIG. 7 is used.

By thus using the format from which the parity is omitted, it becomes possible to efficiently use the communication bandwidth and enhance the communication efficiency. Further, by omitting processing according to error correction using the parity, it becomes possible to reduce the power consumption.

Note that, with the format from which the parity is omitted, parity-omitted information indicating that the parity is omitted is recorded in, for example, the headers HB0 to HB3 or the control code SS. On the basis of this information, the receiver 22 is capable of immediately determining the presence/absence of the parity.

<Configuration Example of Phase Detection Image Data Packet>

Next, a configuration example of the phase detection image data packet will be described with reference to FIG. 8. Note that, the packet header of the phase detection image data packet is set to have a configuration similar to the phase detection image information packet described above with reference to FIG. 5, as shown in the upper section of FIG. 8. It should be noted that, regarding information indicating the display type of the header HB1 that is a 2nd byte, any of values of h08 to 0Fh, which are not set (DisplayPort RESERVED), is allocated. For example, 09h may be allocated as the information indicating the phase detection image data packet.

Regarding the data packets of the phase detection image data packet, pieces of ZAF pixel data are sequentially stored in the data DB0 to DB15.

For example, as shown in the middle section of FIG. 8, if ZAF pixel data AF0[9:0] to AF15[9:0] . . . , which are 10 bits and formed of data of a 0th bit to a ninth bit from the left in the figure, are configured, each set of 8 bits is allocated to the data DB0 to DB15 and transferred as shown in the lower section of FIG. 8. Note that, in the lower section of FIG. 8, data arrangement in being transmitted through the four lanes is shown and data arrangement of Lane 0 to Lane 3 from above is shown. Note that [9:0] indicates from the top bit (0) to a 10th bit (9).

That is, in the lane 0, AF1[9:2] of the top ZAF pixel data AF0[9:0] is allocated to the top one-byte data DB0 from the left to the right in the figure.

Eight bits formed of AF0[1:0] of the top ZAF pixel data AF0[9:0] and AF4[9:4] of the 5th ZAF pixel data AF4[9:0] are allocated to the second one-byte data DB1 of the lane 0.

Eight bits formed of AF4[3:0] of the 5th ZAF pixel data AF4[9:0] and AF8[9:6] of the 9th ZAF pixel data AF8[9:0] are allocated to the third one-byte data DB2 of the lane 0.

Eight bits formed of the 9th ZAF pixel data AF8[5:0] and the 13th ZAF pixel data AF12[9:8] are allocated to the fourth one-byte data DB3 of the lane 0.

Eight bits of the 13th ZAF pixel data AF12[7:0] are allocated to the fifth one-byte data DB16 of the lane 0.

Further, in the lane 1, eight bits of the 2nd ZAF pixel data AF1[9:2] are allocated to top one-byte data DB4.

Eight bits formed of the 2nd ZAF pixel data AF1[1:0] and the 6th ZAF pixel data AF5[9:4] are allocated to the second one-byte data DB5 of the lane 1.

Eight bits formed of the 6th ZAF pixel data AF5[3:0] and the 10th ZAF pixel data AF9[9:6] are allocated to the third one-byte data DB6 of the lane 1.

Eight bits formed of the 10th ZAF pixel data AF9[5:0] and the 14th ZAF pixel data AF13[9:8] are allocated to the fourth one-byte data DB7 of the lane 1.

Eight bits formed of the 14th ZAF pixel data AF13[7:0] are allocated to the fifth one-byte data DB20 of the lane 1.

In addition, in the lane 2, eight bits of the 3rd ZAF pixel data AF2[9:2] are allocated to top one-byte data DB8.

Eight bits formed of the 3rd ZAF pixel data AF2[1:0] and the 7th ZAF pixel data AF6[9:4] are allocated to the second one-byte data DB9 of the lane 2.

Eight bits formed of the 7th ZAF pixel data AF6[3:0] and the 11th ZAF pixel data AF10[9:6] are allocated to the third one-byte data DB6 of the lane 2.

Eight bits formed of the 11th ZAF pixel data AF10[5:0] and the 15th ZAF pixel data AF14[9:8] are allocated to the fourth one-byte data DB11 of the lane 2.

Eight bits of the 15th ZAF pixel data AF14[7:0] are allocated to the fifth one-byte data DB24 of the lane 2.

Further, in the lane 3, eight bits of the 4th ZAF pixel data AF3[9:2] are allocated to top one-byte data DB12.

Eight bits formed of the 4th ZAF pixel data AF3[1:0] and the 8th ZAF pixel data AF7[9:4] are allocated to the second one-byte data DB13 of the lane 3.

Eight bits formed of the 8th ZAF pixel data AF7[3:0] and the 12th ZAF pixel data AF11[9:6] are allocated to the third one-byte data DB14 of the lane 3.

Eight bits formed of the 12th ZAF pixel data AF11[5:0] and the 16th ZAF pixel data AF15[9:8] are allocated to the fourth one-byte data DB15 of the lane 3.

Eight bits of the 16th ZAF pixel data AF15[7:0] are allocated to the fifth one-byte data DB28 of the lane 3.

Note that the transmission form is similar to that of the phase information image information packet described above with reference to FIGS. 6 and 7. Therefore, a description thereof will be omitted.

That is, by using the format based on the SDP, it becomes possible to packetize and transmit and receive the ZAF pixel data.

<Regarding MSA>

Next, the MSA will be described with reference to FIGS. 9 to 11.

During transmission, the MSA are arranged as shown in FIG. 9. In FIG. 9, an arrangement example of the MSA with four lanes is shown. Lane 0 to Lane 3 are shown from the left and chronologically arranged in the up-to-down direction.

Regarding each lane, SS indicating the start of the MSA is continuously arranged twice.

Next, regarding each lane, Mvid23:16, Mvid15:8, and Mvid7:0 from above, which indicate clock frequencies of an identical video stream, are arranged on a byte-by-byte basis. Here, Mvid is information on the clock frequency of the video stream and Mvid23:16 is information of 16th to 23rd bits of the clock frequency of the video stream. Further, Mvid15:8 is information of 8th to 15th bits of the clock frequency of the video stream. In addition, Mvid7:0 is information of 0th to 7th bits of the clock frequency of the video stream.

Regarding Lane0, Htotal15:8 and Htotal7:0 are respectively arranged on a byte-by-byte basis below Mvid. Htotal is the number of pixels in a horizontal direction adding the effective pixel region 71 and the horizontal blanking region 73 as shown in the upper section of FIG. 10. Htotal15:8 and Htotal7:0 are respectively information of 8th to 15th bits of Htotal and information of 0th to 7th bits.

Regarding Lane0, Vtotal15:8 and Vtotal7:0, each of which corresponds to one byte, are arranged below Htotal. Vtotal is the number of lines in a vertical direction adding the number of effective lines of the effective pixel region 71 and the vertical blanking region 72 as shown in the upper section of FIG. 10. Vtotal15:8 and Vtotal7:0 are respectively information of 8th to 15th bits of Vtotal and information of 0th to 7th bits.

Regarding Lane0, HSP/HSW14:8 and HSW7:0, each of which corresponds to one byte, are arranged below Vtotal. HSP is information of one bit indicating a polarity of Hsync (horizontal synchronization signal), active high is 0 and active low is 1 as shown in the middle section of FIG. 10. Further, HSW indicates a pulse width of Hsync. HSP/HSW14:8 is information for one bit of HSP and information of 8th to 14th bits of HSW. HSW7:0 is information of 0th to 7th bits of HSW.

Regarding Lane1, Hstart15:8 and Hstart7:0, each of which corresponds to one byte, are arranged below Mvid. As shown in the lower section of FIG. 10, Hstart is obtained by defining a time from a timing at which last data of a previous line (last data of previous line) ends to a timing at which Hsync arises with the number of pixels. Hstart15:8 and Hstart7:0 are respectively information of 8th to 15th bits of Hstart and information of 0th to 7th bits.

Regarding Lane1, Vstart15:8 and Vstart7:0, each of which corresponds to one byte, are arranged below Hstart. As shown in the middle section of FIG. 10, Vstart is obtained by defining a time from a timing at which last Hsync of the previous frame (last H of previous frame) arises to a timing at which Vsync (vertical synchronization signal) arises with the number of lines. Vstart15:8 and Vstart7:0 are respectively information of 8th to 15th bits of Vstart and information of 0th to 7th bits.

Regarding Lane1, VSP/VSW14:8 and VSW7:0, each of which corresponds to one byte, are arranged below Vstart. VSP is information of one bit indicating a polarity of Vsync (vertical synchronization signal). As shown in the middle section of FIG. 10, active high is 0 and active low is 1. Further, VSW indicates a pulse width of Vsync. VSP/VSW14:8 is information of one bit of VSP and information of 8th to 14th bits of VSW. VSW7:0 is information of 0th to 7th bits of VSW.

On the other hand, regarding Lane2, Hwidth15:8 and Hwidth7:0, each of which corresponds to one byte, are arranged below Mvid. Hwidth is the number of pixels in the horizontal direction of the effective pixel region 71 as shown in the upper part of FIG. 10. Hwidth5:8 and Hwidth7:0 are respectively information of 8th to 15th bits of Hwidth and information of 0th to 7th bits.

Regarding Lane2, Vheight15:8 and Vheight7:0, each of which corresponds to one byte, are arranged below Hwidth. Vheight is the number of lines in the vertical direction of the effective pixel region 71 as shown in the upper part of FIG. 10. Vheight5:8 and Vheight7:0 are respectively information of 8th to 15th bits of Hheight and information of 0th to 7th bits. Note that, regarding Lane2, two bytes below Vheight are set to be blank (All 0s).

Regarding Lane3, Nvid23:16, Nvid15:8, and Nvid7:0 from above, each of which corresponds to one byte, are arranged below Mvid. Nvid is a link clock frequency. Nvid23:16, Nvid15:8, and Nvid7:0 are respectively information of 23rd to 16th bits of Nvid, information of 8th to 15th bits, and information of 0th to 7th bits.

Note that Video Stream clock [Mz]=Mvid/Nvid×Link clock [Mz].

Regarding Lane3, MISC0_7:0 and MISC1_7:0 from above, each of which corresponds to one byte, are arranged below Nvid. MISC0_7:0 and MISC1_7:0 are information on an encoding format.

<Regarding Encoding Format Shown in MISC>

MISC0_7:0 and MISC1_7:0 records the information on the encoding format as shown in FIG. 11, for example.

That is, as shown in the uppermost row of the upper section of FIG. 11, if the 7th bit of MISC1 is 0 and the 1st to 4th bits of MISC0 are 0000, it indicates that the format is an RGB unspecified color space (legacy RGB mode). In addition, if 5th to 7th bits of MISC0 are 000, 001, 010, 011, or 100, it indicates that they are respectively 6, 8, 10, 12, or 16 bits/color.

As shown in the second row of the upper section of FIG. 11, if the 7th bit of MISC1 is 0 and 1st to 4th bits of MISC0 are 0010, it indicates that the format is CEA RGB (sRGB primaries). In addition, if 5th to 7th bits of MISC0 are 000, 001, 010, 011, or 100, it indicates that they are respectively 6, 8, 10, 12, or 16 bits/color.

As shown in the third row of the upper section of FIG. 11, if the 7th bit of MISC1 is 0 and 1st to 4th bits of MISC0 are 1100, it indicates that the format is RGB wide gamut fixed point (XR8, XR10, XR12). In addition, if 5th to 7th bits of MISC0 are 001, 010, or 011, it indicates that they are respectively 8, 10, or 12 bits/color.

As shown in the fourth row of the upper section of FIG. 11, if the 7th bit of MISC1 is 0 and 1st to 4th bits of MISC0 are 1101, it indicates that the format is RGB wide gamut fixed point (scRGB). In addition, if 5th to 7th bits of MISC0 are 100, it indicates that they are 16 bits/color.

As shown in the fifth row of the upper section of FIG. 11, the 7th bit of MISC1 is 1 and 1st to 4th bits of MISC0 are 0000, it indicates that the format is Y-only (luminance only). In addition, if 5th to 7th bits of MISC0 are 001, 010, 011, or 100, it indicates that they are respectively 8, 10, 12, or 16 bits/luminance.

As shown in the sixth row of the upper section of FIG. 11, if the 7th bit of MISC1 is 0, the 1st and 2nd bits of MISC0 are 01 or 10, the 3rd bit is 1, and the 4th bit is 0 or 1, it indicates that the format is YCbCr (ITU601/ITU709). Further, at this time, it is 422 format if the 1st and 2nd bits are 01 or it is 444 format if the 1st and 2nd bits are 10. In addition, at this time, if the 4th bit is 0, it indicates that the format is YCbCr (ITU601), or if the 4th bit is 1, it indicates that the format is YCbCr (ITU709). Further, if 5th to 7th bits of MISC0 are 001, 010, 011, or 100, it indicates that they are respectively 8, 10, 12, or 16 bits/color.

As shown in the seventh row of the upper section of FIG. 11, if the 7th bit of MISC1 is 0, the 1st and 2nd bits of MISC0 are 01 or 10, the 3rd bit is 0, and the 4th bit is 0 or 1, it indicates that the format is xvYCC (xvYCC601/xvYCC709). At this time, it is 422 format if the 1st and 2nd bits are 01 or it is 444 format if the 1st and 2nd bits are 10. Further, if the 4th bit is 0, it indicates that the format is xvYCC (xvYCC601), or if the 4th bit is 1, it indicates that the format is xvYCC (xvYCC709). In addition, if 5th to 7th bits of MISC0 are 001, 010, 011, or 100, it indicates that they are respectively 8, 10, 12, or 16 bits/color.

As shown in the eighth row of the upper section of FIG. 11, if the 7th bit of MISC1 is 0 and the 1st to 4th bits of MISC0 are 0011, it indicates that the format is Adobe (trademark) RGB. In addition, if 5th to 7th bits of MISC0 are 000, 001, 010, 011, or 100, it indicates that they are respectively 6, 8, 10, 12, or 16 bits/color.

As shown in the ninth row of the upper section of FIG. 11, if the 7th bit of MISC1 is 0 and the 1st to 4th bits of MISC0 are 1110, it indicates that the format is DCI-P3. In addition, if 5th to 7th bits of MISC0 are 011 and 100, it indicates that they are respectively 12 or 16 bits/color.

As shown in the 10th row of the upper section of FIG. 11, if the 7th bit of MISC1 is 0 and the 1st to 4th bits of MISC0 are 1111, it indicates that the format is Color Profile. In addition, if 5th to 7th bits of MISC0 are 001, 010, 011, or 100, it indicates that they are respectively 8, 10, 12, or 16 bits/color.

As shown in the uppermost row of the lower section of FIG. 11, the 0th bit of MISC0 is a (Video Stream_Clk/LS_CLK) synchronization flag between a video stream clock and a link clock, where 0 indicates asynchronization and 1 indicates synchronization. In a case of synchronization, Mvid becomes a fixed value.

As shown in the second row of the lower section of FIG. 11, the 0th bit of MISC1 is an even-number flag indicating whether or not Vtotal number in a case of the interlace is an even number, where 1 indicates an even number and 0 indicates an odd number.

As shown in the third row of the lower section of FIG. 11, the 1st to 2nd bits of MISC1 indicate stereoscopic video (3D) characteristics and 00 indicates being non-stereoscopic or transmitting a stereoscopic image by using a video stream configuration (VSC) of the SDP. Further, if the 1st to 2nd bits of MISC1 are 01, it indicates that the next frame is a progressive right-eye image (RIGHT_EYE@Side-by-Side, progressive). At this time, it indicates that the top image is a right-eye image of the interlace (RIGHT_EYE@Top, interlace) and the bottom image is a left-eye image of the interlace (LEFT_EYE@Bottom, interlace). Further, if the 1st to 2nd bits of MISC1 are 10, it indicates being not set (Reserved), or if the 1st to 2nd bits of MISC1 are 11, it indicates that the next frame is a progressive left-eye image (LEFT_EYE@Side-by-Side, progressive), where it indicates that the top image is an interlace left-eye image (LEFT_EYE@Top, interlace) and the bottom image is an interlace right-eye image (RIGHT_EYE@Bottom, interlace).

Note that the 4th to 6th bits of MISC1 are not set (Reserved). Therefore, for example, information required for identifying a transmission source may be added to the 4th to 6th bits of MISC1.

By doing so, it becomes possible to identify a device that is a transmission source of visible image data including ZAF image data. For example, adding information indicating that an image transmission source is an image sensor enables the fact that the transmission source is an image sensor such as an image pickup device, for example, to be recognized.

<Transmission and Reception Processing>

Next, transmission and reception processing in the transmission system of FIG. 1 will be described with reference to the flowchart of FIG. 12.

In Step S11, the controller 44 of the transmitter 21 controls the AUX (auxiliary communication unit) 45 to inquires the receiver 22 about whether or not the processing compatible with the format from which the parity is omitted is possible and check it.

In Step S31, the controller 66 of the receiver 22 controls the AUX (auxiliary communication unit) 65 to determine whether or not the inquiry about whether or not the processing compatible with the format from which the parity is omitted is possible has been received from the transmitter 21. In Step S31, for example, if it is determined in the processing of Step S11 that the inquiry about whether or not the processing compatible with the format from which the parity is omitted is possible has been received, the processing proceeds to Step S32.

In Step S32, the controller 66 checks information stored in the register 67 and reads parity-compatible information indicating whether or not the processing compatible with the format from which the parity is omitted is possible. The register 67 described here is, for example, a region not set (Reserved) of 0090h to 00FFh included in Capabirity field in DPCD (DisplayPort Configuration Data) defined by DisplayPort (trademark). In this case, the parity-compatible information indicating whether or not the processing compatible with the format from which the parity is omitted is possible is recorded in advance in the region not set (Reserved) of 0090h to 00FFh included in this Capabirity field.

In Step S33, the controller 66 controls the AUX 65 to transmit the parity-compatible information indicating whether or not the processing compatible with the format from which the parity is omitted is possible, which is read from the register 67, to the transmitter 21.

In the step 12, the controller 44 of the transmitter 21 controls the AUX 45 to determine whether or not the processing compatible with the format from which the parity is omitted is possible, on the basis of the parity-compatible information indicating whether or not the processing compatible with the format from which the parity is omitted is possible, which is transmitted from the receiver 22.

In Step S12, for example, if it is determined in Step S13 that the parity-compatible information is the information indicating that the processing compatible with the format from which the parity is omitted is possible, the controller 45 instructs the SDP generator 42 to generate the SDP by using the format from which the parity is omitted. Note that, if it is determined in Step S12 that the parity-compatible information indicates that the processing compatible with the format from which the parity is omitted is not possible or if the parity-compatible information is not transmitted, the processing of Step S13 is skipped. Thus, in this case, the SDP generator 42 generates the SDP by using the normal format.

In Step S14, the MSA generator 41 generates the above-mentioned MSA of visible image data to be transmitted, which are formed of information on the number of lines per frame, the number of pixels per line, and the number of bits per pixel of phase detection image data, and supplies them to the multiplexer 43.

In Step S15, the SDP generator 42 generates the above-mentioned SDP on the basis of the ZAF image data. That is, if the SDP generator 42 is instructed to generate the SDP by using the format from which the parity is omitted through the processing of Step S13 on the basis of the parity-compatible information, the SDP generator 42 generates the phase detection image information packet and the phase detection image data packet in the SDP by using the format from which the parity is omitted. In this case, the SDP generator 42 records the parity-omitted information indicating the format from which the parity is omitted, in the headers HB0 to HB3, the control code SS, or the like. Further, if the processing of Step S13 is skipped, the SDP generator 42 generates the SDP by using the normal format from which the parity is not omitted.

In Step S16, the multiplexer 43 multiplexes the MSA, the SDP, and the visible image data to generate multiplexed data.

In Step S17, the multiplexer 43 transmits the multiplexed data to the receiver 22.

In Step S18, the transmission unit 21 determines whether or not a next image signal is absent and an instruction to terminate the processing is performed. If the instruction to terminate the processing is not performed, the processing returns to

Step S14 and the subsequent processing is repeated. Then, if the instruction to terminate the processing is performed in Step S18, the processing ends.

On the other hand, in the receiver 22, the division unit 61 receives the multiplexed data in Step S34.

In Step S35, the division unit 61 divides the multiplexed data into the MSA, the SDP, and the visible image data and supplies the MSA to the MSA reader 62, the SDP to the SDP reader 63, and the visible image data to the image generator 64.

In Step S36, the MSA reader 62 reads, from the information on the MSA, the information on the number of lines per frame, the number of pixels per line, and the number of bits per pixel of the visible image data, and supplies it to the image generator 64.

In Step S37, the controller 66 checks the headers HB0 to HB3 or the control code SS, checks the presence/absence of the parity-omitted information, and instructs the SDP reader 63 to perform processing as being in the format from which the parity is omitted or perform processing as being in the normal format. In accordance with this instruction, the SDP reader 63 reads the phase detection image information packet and the phase detection image data packet of the SDP and extracts the ZAF image data from the phase detection image data on the basis of the information on the phase detection image information packet and outputs it. Thus, if the parity-omitted information is present, the SDP reader 63 reads the SDP as being in the format from which the parity is omitted. Further, if the parity-omitted information is not present and handling has to be performed as being in the normal format or if the parity-omitted information is not present, the SDP reader 63 reads the SDP as being in the normal format.

In Step S38, the image generator 64 reconfigures the visible image from the visible image data on the basis of the MSA and outputs it.

In Step S39, the receiver 22 determines whether or not a next image signal is absent and an instruction to terminate the processing is performed. If the instruction to terminate the processing is not performed, the processing returns to Step S34 and the subsequent processing is repeated. Then, if the instruction to terminate the processing is performed in Step S39, the processing ends.

Note that the example in which, for starting the transmission and reception processing, the transmitter 21 inquires the receiver 22, checks whether or not it is compatible with the format from which the parity is omitted, and instructs the SDP generator 42 to generate the SDP by using the format depending on the check result has been described above. However, if the receiver 22 cannot check from the transmitter 21 whether or not it is compatible with the format from which the parity is omitted, it may be considered that it is not compatible with the format from which the parity is omitted and processing may be performed by using the normal format.

Further, if receiving the multiplexed data before inquired about whether or not it is compatible with the format from which the parity is omitted, the receiver 22 may skip the processing of Steps S31 to S33 and start the processing from Step S34 and perform processing as being in the normal format.

In addition, whether or not to use the format from which the parity is omitted may be determined in a manner that depends on the type of the additional data and the format may be switched in a manner that depends on needs.

Although the example in which the ZAF image data is transmitted and received as the additional data has been described above, other data may be transmitted and received in accordance with a similar technique. For example, thumbnail images or the like may be transmitted and received. If additional data that does not require real-time reliability like thumbnail images or the like, the parity may be omitted. Further, as a matter of course, audio data can also be transmitted as the additional data through similar processing. In this case, error correction information formed of the parity is used as it is. Therefore, the processing of Steps S11 to S13 and Steps S31 to S33 is skipped.

In the above-mentioned processing, the SDP is used and the ZAF image data is packetized. Thus, it becomes possible to transmit the visible image data and to add the packetized ZAF image data to the horizontal blanking region and the vertical blanking region and transmit them.

Further, in the above-mentioned processing, in a manner that depends on the type of the additional data and whether or not the receiver 22 is compatible with the format without the parity, it becomes possible to use the format for transmitting the SDP by switching the presence/absence of the parity. With this, in a case where audio data or the like is transmitted and received as the additional data as is conventionally done, real-time transmission and reception having high reliability are made possible by adding 4-byte parity to 16 bytes. Further, in transmitting the additional data such as the ZAF image and the thumbnail image, for which the real-time reliability should not be considered as important, it becomes possible to enhance the communication efficiency and reduce the power consumption associated with the communication by using the format from which the error correction function of the parity is omitted.

By the way, the above-mentioned series of processing may be executed by hardware or may be executed by software. If the series of processing is executed by software, programs that configure that software are installed, from the recording medium, in a computer incorporated in dedicated hardware or for example, a general-purpose personal computer capable of executing various functions by installing various programs.

FIG. 13 shows a configuration example of a general-purpose personal computer. This personal computer includes a built-in CPU (Central Processing Unit) 1001. An input/output interface 1005 is connected to the CPU 1001 via a bus 1004. A ROM (Read Only Memory) 1002 and a RAM (Random Access Memory) 1003 are connected to the bus 1004.

A communication unit 1009 is connected to the input/output interface 1005. The communication unit 1009 is constituted by an input unit 1006 constituted by input devices such as a keyboard and a mouse into which a user inputs operation commands, an output unit 1007 that outputs processing operation screens and images of processing results to a display device, a storage unit 1008 constituted by a hard disk drive that stores programs and various types of data and the like, a LAN (Local Area Network) adaptor, and the like. The communication unit 1009 executes communication processing via a network represented by the Internet. Further, a drive 1010 is connected thereto. The drive 1010 reads and writes data from/in the removable medium 1011 such as a magnetic disk (including flexible disk), an optical disc (including CD-ROM (Compact Disc-Read Only Memory) and DVD (Digital Versatile Disc)), a magneto-optical disk (including MD (Mini Disc)), and a semiconductor memory.

The CPU 1001 executes various types of processing in accordance with the programs stored in the ROM 1002 or programs read from a removable medium 1011 such as a magnetic disk, an optical disc, a magneto-optical disk, and a semiconductor memory, installed into the storage unit 1008, and loaded into the RAM 1003 from the storage unit 1008. Data and the like necessary for the CPU 1001 to execute various types of processing are further stored in the RAM 1003 if necessary.

In the thus configured computer, the CPU 1001 loads, for example, programs stored in the storage unit 1008 into the RAM 1003 via the input/output interface 1005 and the bus 1004 and executes them. In this manner, the above-mentioned series of processing is performed.

Programs executed by the computer (CPU 1001) can be, for example, recorded and provided in the removable medium 1011 that is a package medium. Further, the programs can be provided via a wired or wireless transmission medium such as a local area network, the Internet, and digital satellite broadcasting.

In the computer, the programs can be installed into the storage unit 1008 via the input/output interface 1005 by the removable medium 1011 being mounted on the drive 1010. Further, the programs can be received by the communication unit 1009 via the wired or wireless transmission medium and installed into the storage unit 1008. Otherwise, the programs can be installed into the ROM 1002 and the storage unit 1008 in advance.

Note that the programs executed by the computer may be programs are processed chronologically in the order described in the present specification or may be programs processed concurrently or at necessary timings, for example, upon calling.

Therefore, a plurality of apparatuses housed in separate casings and connected via a network and a single apparatus including a plurality of modules housed within a single casing are both systems.

Note that embodiments of the present technology are not limited to the above-mentioned embodiments and various modifications can be made without departing from the gist of the present technology.

For example, the present technology can take a cloud computing configuration in which a single function is shared and cooperatively processed by a plurality of apparatuses via a network.

Further, the respective steps described above with reference to the above-mentioned flowcharts can be shared and executed by a plurality of apparatuses rather than being executed by a single apparatus.

In addition, if a single step includes a plurality of processes, the plurality of processes of the single step can be shared and executed by a plurality of apparatuses rather than being executed by a single apparatus.

It should be noted that the present technology can also take the following configurations.
(1) A transmission apparatus that transmits visible image data formed of effective pixel data of an image pickup apparatus by using a format for transmitting to a display, the transmission apparatus including

a transmitter that transmits audio data in addition to the visible image data, in which

in the format, an error correction code having a predetermined amount is set with respect to the audio data having a predetermined amount, and

the transmitter transmits, transmitting additional data different from the audio data instead of the audio data in addition to the visible image data, the additional data and the visible image data by using the format from which a part of the error correction code is omitted.
(2) The transmission apparatus according to (1), in which

the transmitter inquires a transmission destination about whether or not the additional data can be transmitted with the part of the error correction code included in the format being omitted, and transmits the additional data in addition to the visible image data by using the format from which the part of the error correction code is omitted if the additional data can be transmitted with the part of the error correction code included in the format being omitted.
(3) The transmission apparatus according to (1) or (2), in which

the transmitter uses the format for transmitting to the display and packetizes and transmits the phase detection image data in the image pickup apparatus as the additional data.
(4) The transmission apparatus according to (3), in which

the format for transmitting to the display is a format defined by DisplayPort (trademark), and

the transmitter uses an SDP (Secondary-Data Packet) defined by DisplayPort (trademark) as the format for transmitting to the display and packetizes and transmits the phase detection image data as the additional data in the image pickup apparatus.
(5) The transmission apparatus according to (4), in which

the transmitter uses a phase detection image information packet and a phase detection image data packet of the SDP (Secondary-Data Packet) defined by DisplayPort (trademark) and packetizes and transmits the phase detection image data as the additional data in the image pickup apparatus.
(6) The transmission apparatus according to (5), in which

the transmitter arranges the phase detection image information packet in a vertical blanking region, arranges the phase detection image data packet in a horizontal blanking region, and packetizes and transmits the phase detection image data.
(7) The transmission apparatus according to (5), in which

the phase detection image information packet includes information on the number of lines per frame and the number of pixels per line of the phase detection image constituted by the phase detection image data, the number of bits per pixel, and the number of pixels per piece of the phase detection image data.
(8) The transmission apparatus according to (5), in which

the transmitter packages and transmits the phase detection image data packet in units of predetermined bytes.
(9) A transmission method for a transmission apparatus that transmits visible image data formed of effective pixel data of an image pickup apparatus by using a format for transmitting to a display, the transmission method including

a transmission step of transmitting audio data in addition to the visible image data,

in the format, an error correction code having a predetermined amount is set with respect to the audio data having a predetermined amount, and

processing of the transmission step includes transmitting, transmitting additional data different from the audio data instead of the audio data in addition to the visible image data, the additional data and the visible image data by using the format from which a part of the error correction code is omitted. (10) A program that causes a computer that controls a transmission apparatus that transmits visible image data formed of effective pixel data of an image pickup apparatus by using a format for transmitting to a display to execute

processing including a transmission step of transmitting phase detection image data in the image pickup apparatus in addition to the visible image data, in which

in the format, an error correction code having a predetermined amount is set with respect to the audio data having a predetermined amount, and

processing of the transmission step includes transmitting, transmitting additional data different from the audio data instead of the audio data in addition to the visible image data, the additional data and the visible image data by using the format from which a part of the error correction code is omitted.
(11) A reception apparatus that receives visible image data formed of effective pixel data of an image pickup apparatus by using a format for transmitting to a display, the reception apparatus including

a receiver that receives audio data in the image pickup apparatus in addition to the visible image data, in which

in the format, an error correction code having a predetermined amount is set with respect to the audio data having a predetermined amount, and

the receiver receives, in receiving additional data different from the audio data instead of the audio data in addition to the visible image data, the additional data and the visible image data by using the format from which a part of the error correction code is omitted.
(12) A reception method for a reception apparatus that receives visible image data formed of effective pixel data of an image pickup apparatus by using a format for transmitting to a display, the reception method including

a step of receiving audio data in the image pickup apparatus in addition to the visible image data, in which

in the format, an error correction code having a predetermined amount is set with respect to the audio data having a predetermined amount, and

processing of the reception step includes receiving, in receiving additional data different from the audio data instead of the audio data in addition to the visible image data, the additional data and the visible image data by using the format from which a part of the error correction code is omitted.
(13) A program that causes a computer that controls a reception apparatus that receives visible image data formed of effective pixel data of an image pickup apparatus by using a format for transmitting to a display to execute

processing including a reception step of receiving audio data in the image pickup apparatus in addition to the visible image data,

in the format, an error correction code having a predetermined amount is set with respect to the audio data having a predetermined amount, and

processing of the reception step includes receiving, in receiving additional data different from the audio data instead of the audio data in addition to the visible image data, the additional data and the visible image data by using the format from which a part of the error correction code is omitted.
(14) A transmission system including:

a transmission apparatus that transmits visible image data formed of effective pixel data of an image pickup apparatus by using a format for transmitting to a display; and

a reception apparatus, in which

the transmission apparatus includes
a transmitter that transmits, to the reception apparatus, audio data in the image pickup apparatus in addition to the visible image data,

in the format, an error correction code having a predetermined amount is set with respect to the audio data having a predetermined amount,

the transmitter transmits, transmitting additional data different from the audio data instead of the audio data in addition to the visible image data, the additional data and the visible image data by using the format from which a part of the error correction code is omitted,

the reception apparatus includes
a receiver that receives, from the transmission apparatus, the audio data in the image pickup apparatus in addition to the visible image data, and
the receiver receives, in receiving the additional data different from the audio data instead of the audio data in addition to the visible image data, the additional data and the visible image data by using the format from which the part of the error correction code is omitted.

### REFERENCE SIGNS LIST

21 transmitter, 22 receiver, 41 MSA generator, 42 SDP generator, 43 multiplexer, 44 controller, 45 AUX (auxiliary communication unit), 61 division unit, 62 MSA reader, 63 SDP reader, 64 image generator, 65 AUX (auxiliary communication unit), 66 controller, 67 register

1. A transmission apparatus that transmits visible image data formed of effective pixel data of an image pickup apparatus by using a format for transmitting to a display, the transmission apparatus comprising
a transmitter that transmits audio data in addition to the visible image data, wherein
in the format, an error correction code having a predetermined amount is set with respect to the audio data having a predetermined amount, and
the transmitter transmits, transmitting additional data different from the audio data instead of the audio data in addition to the visible image data, the additional data and the visible image data by using the format from which a part of the error correction code is omitted.

2. The transmission apparatus according to claim 1, wherein
the transmitter inquires a transmission destination about whether or not the additional data can be transmitted with the part of the error correction code included in the format being omitted, and transmits the additional data in addition to the visible image data by using the format from which the part of the error correction code is omitted if the additional data can be transmitted with the part of the error correction code included in the format being omitted.

3. The transmission apparatus according to claim 1, wherein
the transmitter uses the format for transmitting to the display and packetizes and transmits the phase detection image data in the image pickup apparatus as the additional data.

4. The transmission apparatus according to claim 3, wherein
the format for transmitting to the display is a format defined by DisplayPort (trademark), and
the transmitter uses an SDP (Secondary-Data Packet) defined by DisplayPort (trademark) as the format for transmitting to the display and packetizes and transmits the phase detection image data as the additional data in the image pickup apparatus.

5. The transmission apparatus according to claim 4, wherein
the transmitter uses a phase detection image information packet and a phase detection image data packet of the SDP (Secondary-Data Packet) defined by DisplayPort (trademark) and packetizes and transmits the phase detection image data as the additional data in the image pickup apparatus.

6. The transmission apparatus according to claim 5, wherein
the transmitter arranges the phase detection image information packet in a vertical blanking region, arranges the phase detection image data packet in a horizontal blanking region, and packetizes and transmits the phase detection image data.

7. The transmission apparatus according to claim 5, wherein
the phase detection image information packet includes information on the number of lines per frame and the number of pixels per line of the phase detection image constituted by the phase detection image data, the number of bits per pixel, and the number of pixels per piece of the phase detection image data.

8. The transmission apparatus according to claim 5, wherein
the transmitter packages and transmits the phase detection image data packet in units of predetermined bytes.

9. A transmission method for a transmission apparatus that transmits visible image data formed of effective pixel data of an image pickup apparatus by using a format for transmitting to a display, the transmission method comprising
a transmission step of transmitting audio data in addition to the visible image data,
in the format, an error correction code having a predetermined amount is set with respect to the audio data having a predetermined amount, and
processing of the transmission step includes transmitting, transmitting additional data different from the audio data instead of the audio data in addition to the visible image data, the additional data and the visible image data by using the format from which a part of the error correction code is omitted.

10. A program that causes a computer that controls a transmission apparatus that transmits visible image data formed of effective pixel data of an image pickup apparatus by using a format for transmitting to a display to execute
processing including a transmission step of transmitting phase detection image data in the image pickup apparatus in addition to the visible image data, wherein
in the format, an error correction code having a predetermined amount is set with respect to the audio data having a predetermined amount, and
processing of the transmission step includes transmitting, transmitting additional data different from the audio data instead of the audio data in addition to the visible image data, the additional data and the visible image data by using the format from which a part of the error correction code is omitted.

11. A reception apparatus that receives visible image data formed of effective pixel data of an image pickup apparatus by using a format for transmitting to a display, the reception apparatus comprising
a receiver that receives audio data in the image pickup apparatus in addition to the visible image data, wherein
in the format, an error correction code having a predetermined amount is set with respect to the audio data having a predetermined amount, and
the receiver receives, in receiving additional data different from the audio data instead of the audio data in addition to the visible image data, the additional data and the visible image data by using the format from which a part of the error correction code is omitted.

12. A reception method for a reception apparatus that receives visible image data formed of effective pixel data of an image pickup apparatus by using a format for transmitting to a display, the reception method comprising
a step of receiving audio data in the image pickup apparatus in addition to the visible image data, wherein
in the format, an error correction code having a predetermined amount is set with respect to the audio data having a predetermined amount, and
processing of the reception step includes receiving, in receiving additional data different from the audio data instead of the audio data in addition to the visible image data, the additional data and the visible image data by using the format from which a part of the error correction code is omitted.

13. A program that causes a computer that controls a reception apparatus that receives visible image data formed of effective pixel data of an image pickup apparatus by using a format for transmitting to a display to execute
processing including a reception step of receiving audio data in the image pickup apparatus in addition to the visible image data,
in the format, an error correction code having a predetermined amount is set with respect to the audio data having a predetermined amount, and
processing of the reception step includes receiving, in receiving additional data different from the audio data instead of the audio data in addition to the visible image data, the additional data and the visible image data by using the format from which a part of the error correction code is omitted.

14. A transmission system comprising:
a transmission apparatus that transmits visible image data formed of effective pixel data of an image pickup apparatus by using a format for transmitting to a display; and
a reception apparatus, wherein
the transmission apparatus includes
a transmitter that transmits, to the reception apparatus, audio data in the image pickup apparatus in addition to the visible image data,
in the format, an error correction code having a predetermined amount is set with respect to the audio data having a predetermined amount,
the transmitter transmits, transmitting additional data different from the audio data instead of the audio data in addition to the visible image data, the additional data and the visible image data by using the format from which a part of the error correction code is omitted,
the reception apparatus includes
a receiver that receives, from the transmission apparatus, the audio data in the image pickup apparatus in addition to the visible image data, and
the receiver receives, in receiving the additional data different from the audio data instead of the audio data in addition to the visible image data, the additional data and the visible image data by using the format from which the part of the error correction code is omitted.
